(19) United States
(12) Patent Application Publication
(10) Pub. No.: US 2003/0013902 A1
(43) Pub. Date: Jan. 16, 2003

(54) Solvents for trialkoxysilane synthesis

(76) Inventors: Alexandra Brand, Darmstadt (DE); Eva Freudenthaler, Ludwigshafen (DE); Thomas Narbeshuber, Ibbenburen (DE)

Correspondence Address: Keil & Weinkauf, 1101 Connecticut Avenue NW, Washington, DC, 20036, US

(21) Appl. No.: 10/168,954

(22) PCT Filed: Dec. 15, 2000
(86) PCT No.: PCT/EP00/12849

(30) Foreign Application Priority Data
Dec. 23, 1999 (DE) 199 62 571.9

(51) Int. Cl. C07F 7/02

(52) U.S. Cl. 556/472

(57) ABSTRACT

In a process for preparing trialkoxysilanes by reacting silicon metal with an alcohol over a copper-containing catalyst in an inert reaction medium, the inert reaction medium comprises diphenylalkanes.

The present invention relates to a process for preparing trialkoxysilanes by reacting silicon metal with an alcohol.

Trialkoxysilanes made up of a silicon atom to which three alkoxy groups and one hydrogen atom are bound are very reactive and unstable. They therefore undergo numerous reactions such as additions, copolymerizations, copolycondensations and disproportionation reactions with other organic compounds, giving a series of very useful substances. These are in turn employed as starting materials for silane coupling reagents, coating compositions, heat-resistant surface coatings or for producing high-purity monosilanes for semiconductor applications.

Trialkoxysilanes are customarily prepared by direct reaction of silicon metal with the corresponding alcohols at from 150 to 300° C. using copper-containing catalysts (direct synthesis). The industrially and economically most interesting processes employ inert heat transfer oils as reaction medium. In this case, the copper-containing silicon composition is generally suspended in an inert, liquid reaction medium and reacted to form the desired trialkoxysilanes by introducing liquid or gaseous alcohol into the suspension at from 150 to 300° C. The maximum temperature at which this process can be carried out is determined by the thermal stability of the reaction medium. The reaction medium therefore has to be highly thermally stable. Furthermore, the type of reaction medium chosen has a great influence on the reactivity of the starting materials and the selectivity of the reaction.

The use of a variety of reaction media is known from the literature.

JP-A 101 82660 relates to the preparation of alkoxysilanes by reacting silicon metal with aliphatic alcohols over a copper salt as catalyst, using biphenyls as reaction medium. JP-A 101 82661 discloses dialkoxybenzenes of the formula C₆H₄(OR)₂, where R is an alkyl radical having from 1 to 4 carbon atoms, as reaction medium. Further reaction media which have been used are mixtures of alkylbenzenes having alkyl chains having a mean number of carbon atoms of from 11 to 13 (JP 5 5076-891), polycyclic aromatic hydrocarbons (JP 4 9055-625), diphenyl ether (JP-A 610 01693), isoparaffins having boiling points of from 260 to 370° C. (JP 5 7108-095), dialkylbenzenes having boiling points of from 300 to 480° C. (JP 5 7108-094), triphenyl halides (JP 5 7099-593) and tritoluenes, tetratoluenes or mixtures thereof (EP-A 0 709 388).

EP-A 0 280 517 relates to the direct synthesis of trialkoxysilanes which comprises an activation step for activating the silicon metal and the copper catalyst, a reaction step in which the alcohol is reacted with the silicon metal over the copper catalyst and a purification step. As reaction medium, it is possible to use any solvent which is stable in the reaction system and at the temperatures employed. In the examples, alkylbenzenes are used as reaction medium.

EP-A 0 835 876 relates to the direct synthesis of trialkoxysilanes, in which a preactivation of the silicon metal and the copper catalyst by means of a reducing agent is likewise carried out. Reaction media used for the subsequent reaction with an alcohol are, for reasons of environmental friendliness and price, preferably alkylated benzenes (NALKYLEN®550BL and NALKYLEN®600L from Vista Chemical Company).

The best results obtained hitherto in respect of the reactivity of the starting materials and the selectivity of the reaction in the direct synthesis of trialkoxysilanes have been obtained using alkyl-substituted aromatic compounds (THERMINOL® 59, product of Monsanto Company (according to the safety data sheet: mixture of diphenylethane, ethyldiphenylethane, diethyldiphenylethane, ethylbenzene polymer)) and mixtures of isomeric dibenzylbenzenes (MARLOTHERM® S, product of Hüls AG) and mixtures of isomeric benzyltoluenes (MARLOTHERM® L, product of Hüls AG) as reaction media (EP-A 0 835 876). A disadvantage of these reaction media is their extremely high price, which is why they play a dominant role in the process costs.

It is an object of the present invention to provide inexpensive reaction media (heat transfer oils) for the direct synthesis of trialkoxysilanes, which media make a very good reactivity of the starting materials and selectivity of the reaction possible and require no preactivation of the starting materials. In the present context, a very good reactivity of the starting materials means a very high conversion of the alcohol and the silicon metal per unit time, and selectivity of the reaction refers to the ratio of desired trimethoxysilane to the tetramethoxysilane formed as by-product.

We have found that this object is achieved by a process for preparing trialkoxysilanes by reacting silicon metal with an alcohol over a copper-containing catalyst in an inert reaction medium when the inert reaction medium comprises diphenylalkanes.

Here, the diphenylalkanes can be used as reaction medium in pure form, as a mixture of various diphenylalkanes or as a mixture with other compounds suitable as reaction medium.

Diphenylalkanes are by-products of the preparation of linear alkylbenzenes and can therefore be procured at a low price. The use of expensive reaction media such as alkyl-substituted aromatic compounds (THERMINOL®59) or mixtures of isomeric dibenzylbenzenes (MARLOTHERM®S) and mixtures of isomeric benzyltoluenes (MARLOTHERM®L) is not necessary. The diphenylalkanes have excellent thermal stability and a very good resistance to substances used and formed in the reaction. The silicon metal and the catalyst can be dispersed very homogeneously, so that heat transfer is good and local overheating is avoided.

The alkyl chains of the diphenylalkanes generally have a chain length of from 3 to 20 carbon atoms, preferably from 10 to 14 carbon atoms. The alkyl chains can be linear or branched. Preference is given to using diphenylalkanes having linear alkyl chains. For price reasons, particular preference is given to using a mixture of diphenylalkanes having alkyl chains having from 10 to 14 carbon atoms as reaction medium.

The diphenylalkanes used as reaction medium generally have boiling ranges within the range from 250 to 450° C., preferably from 340 to 390° C. Their mean molecular weights are generally in the range from 200 to 500 g/mol, preferably from 300 to 350 g/mol.

Small amounts of residual chlorine compounds in the reaction medium do not adversely affect the reaction. Depending on the desired reaction, they may even have a positive effect. Residual contents of generally from 0 to 10 000 ppm, preferably from 1 to 1000 ppm, particularly preferably from 100 to 500 ppm, based on the reaction medium, can be present in the reaction medium.

The water content of the reaction medium has no influence on the reaction. Water contents of from 0 to 1 000 ppm, preferably from 1 to 100 ppm, particularly preferably from 10 to 50 ppm, based on the reaction medium, are usual.

The amount of reaction medium used is variable. In general, the ratio of silicon metal to the reaction medium during the reaction is from 4:1 to 1:6, preferably from 2:1 to 1:4, particularly preferably from 1:1 to 1:2.

Copper salts are generally suitable as copper-containing catalysts. Both monovalent and divalent copper salts are suitable as copper salts. Examples of suitable copper-containing catalysts are copper oxides such as copper(I) and copper(II) oxide, copper halides such as copper(I) and copper(II) chloride and copper(I) and copper(II) bromide, copper nitrides, copper salts of lower aliphatic acids such as copper formate and copper acetate, copper carbonates, copper hydroxides, copper cyanides, copper acetylacetonates, copper nitrates and copper naphthenates.

Preference is given to using monovalent or divalent copper salts as copper-containing catalysts. Particular preference is given to copper(II) hydroxides, copper(I) chloride and copper(I) and copper(II)oxides.

The amount of copper-containing catalyst is variable. In general, from 0.0001 to 0.05 mol, preferably from 0.0005 to 0.005 mol, particularly preferably from 0.001 to 0.005 mol, of the catalyst is used per mol of silicon metal.

As silicon metal, it is in principle possible to use any commercially available product. A typical composition of a commercial product which is suitable for the process of the present invention comprises from about 98 to 99% by weight of Si, <1% by weight of Fe, from about 0.05 to 0.7% by weight of Al, from about 0.001 to 0.1% by weight of Ca, <0.001% by weight of Pb and <0.1% by weight of water. Usual average particle diameters are from 45 to 600 μm, preferably from 75 to 300 μm. In general, small particle diameters of the silicon metal are preferred, since they are easier to disperse and react more quickly.

The alcohol used is generally a monohydric alcohol. The alkyl group of the alcohol usually has from 1 to 6 carbon atoms. The alkyl group can be branched or unbranched, but is preferably unbranched. The alkyl group of the alcohol used preferably has from 1 to 3 carbon atoms and particular preference is given to using methanol or ethanol so that the particularly preferred products are trimethoxysilane or triethoxysilane. The alcohol is usually introduced in liquid or gaseous form into a reaction mixture comprising reaction medium, silicon metal and catalyst.

The alcohol is generally added continuously in excess to the initially charged silicon metal (semibatch process). The precise ratio of alcohol to silicon metal depends, inter alia, on the desired work-up method.

In one embodiment of the process of the present invention, the reaction medium comprising diphenylalkanes, the silicon metal and the copper-containing catalyst are placed in a reactor. The mixture is generally heated to the desired reaction temperature and the alcohol is introduced in liquid or gaseous form into the mixture. After the reaction is complete, the reaction medium can be recovered by filtration. During the reaction, further silicon metal can be added at particular time intervals. Further catalyst can be added at the same time. If no further catalyst is added, a slight decrease, which is not critical, in the reactivity of the mixture may be found. In this way, it is possible to react at least 10 times, preferably from 10 to 15 times, the initial amount of silicon metal in the reaction medium used.

The reaction is generally carried out at from 150 to 300° C., preferably from 180 to 300° C. In some cases, an increase in the temperature under otherwise unchanged reaction conditions leads to an improvement in the selectivity, i.e. to an improvement in the ratio of trialkoxysilane to the tetraalkoxysilane formed as undesirable by-product. The reaction pressure is not critical. The reaction is usually carried out under atmospheric pressure.

The present invention further provides for the use of diphenylalkanes as inert reaction medium in the reaction of silicon metal with an alcohol over a copper-containing catalyst.

The following examples illustrate the invention.

### EXAMPLES

### Preparation of Trimethoxysilane

General Method for All the Examples Described Below:

500 ml of reaction medium, 200 g of silicon metal (average particle diameter: 200 μm, silicon content>98%) and about 0.002 mol%, based on the silicon metal, of a catalyst are placed in a 500 ml glass reactor. The reactor is equipped with a thermometer, condenser, stirrer and inlet tube for the alcohol and for nitrogen. The reaction mixture is heated to the reaction temperature indicated in Table 1, and methanol is introduced in liquid form. Shortly after commencement of the introduction of methanol, product begins to condense in the condenser. The composition of the product is determined by means of gas chromatography. To make the results comparable, they were determined at a uniform reaction time of 22.5 hours. After from 23 to 25 hours, the methanol content of the product is 100% and the reactions can then be regarded as complete. The reaction mixture after the reaction is a reddish brown suspension which is filtered. The recovered solvent can be reused.

Table 1 shows the reaction parameters and experimental results obtained in the examples according to the present invention and the comparative examples:

TABLE 1

| | | | MeOH | | | | | | |
|---|---|---|---|---|---|---|---|---|---|
| | | | through- | | | | | | |
| | | | put⁴ | | Amount | | Si | | MeOH |
| | T | | [g(min. | | of cat. | | conversion⁸ | | conversion¹⁰ |
| Ex.¹ | [° C.]² | Reaction med.³ | kg_{Si})] | Cat.⁵ | [g/kg_{Si}]⁶ | t[h]⁷ | [%] | Select.⁹ | [%] |
| 1 | 250 | C₁₀₋₁₄-diphenyl- | 3.07 | Cu(OH)₂ | 6.60 | 20.5 | 70.3 | 91.40 | 67.34 |
| | | alkane | | | | | | | |
| C1a | 250 | THERMINOL ® | 3.14 | Cu(OH)₂ | 6.60 | 22.5 | 83.6 | 93.64 | 69.36 |
| | | 59^{3a} | | | | | | | |
| C1b | 250 | MARLO- | 3.10 | Cu(OH)₂ | 6.60 | 22.5 | 81.2 | 92.20 | 67.69 |
| | | THERM ®SH^{3b} | | | | | | | |
| C1c | 250 | LAB^{3c} | 2.89 | Cu(OH)₂ | 6.60 | 22.5 | 41.5 | 96.84 | 44.19 |
| 2 | 280 | C₁₀₋₁₄-diphenyl- | 3.03 | Cu(OH)₂ | 6.60 | 22.5 | 77.8 | 96.86 | 65.78 |
| | | alkane | | | | | | | |
| 3 | 250 | C₁₀₋₁₄-diphenyl- | 3.05 | CuCl | 6.90 | 22.5 | 72.2 | 85.37 | 63.43 |
| | | alkane | | | | | | | |
| C3a | 250 | MARLO- | 3.17 | CuCl | 6.70 | 22.5 | 71.0 | 84.76 | 59.25 |
| | | THERM ®SH^{3b} | | | | | | | |
| 4 | 280 | C₁₀₋₁₄-diphenyl- | 3.16 | CuCl | 6.90 | 22.5 | 77.6 | 93.02 | 64.44 |
| | | alkane | | | | | | | |

¹Example number, where C denotes a comparative example and a, b denote different comparative examples corresponding to an example according to the present invention
²Reaction temperature, in ° C.
³Reaction medium used;
^{3a)}THERIMINOL ® 59: mixture of diphenylethane, ethyldiphenylethane, diethyldiphenylethane, ethylbenzene polymer from the Monsanto Company;
^{3b)}MARLOTHERM ® SH: mixture of isomeric dibenzylbenzenes from Hüls AG;
^{3c)}LAB: linear alkylbenzene having from 10 to 13 carbon atoms in the alkyl radical
⁴Methanol throughput, in g/(min.kgs_{Si})
⁵Catalyst used
⁶Amount of catalyst used, in g/kg_{Si}
⁷Reaction time, in hours
⁸Silicon conversion, in Si[mol] in the product/amount of Si used
⁹Selectivity, in (trimethoxysilane [mol]/trimethoxysilane [mol] + tetramethoxysilane [mol]) * 100
¹⁰Methanol conversion, in ((3 * trimethoxysilane [mol] + 4 * tetramethoxysilane [mol])/amount of methanol introduced [mol]) * 100

The Following Conclusions can be Drawn from the Table:

If copper(II) hydroxide is chosen as catalyst, the reaction according to the present invention of silicon metal and methanol in diphenylalkane proceeds with a comparably good reactivity (silicon conversion, methanol conversion) and selectivity as in the expensive reaction media MARLOTHERM® SH and THERMINOL® 59 (examples 1, C1a, C1b). The reaction in linear alkylbenzenes, on the other hand, does not go as well (C1c). The selectivity of the reaction in diphenylalkanes can be increased considerably by raising the temperature to 280° C. (example 2 according to the present invention).

When using copper(I) chloride as catalyst, the reactivity (silicon conversion, methanol conversion) and selectivity of the reactions in diphenylalkanes (example 3 according to the present invention) and MARLOTHERM® SH (comparative example C3a) are comparable. Here too, increasing the temperature to 280° C. effects a significant improvement in the selectivity (example 4 according to the present invention).

We claim:

1. A process for preparing trialkoxysilanes by reacting silicon metal with an alcohol over a copper-containing catalyst in an inert reaction medium comprising diphenylalkanes.

2. A process as claimed in claim 1, wherein the diphenylalkanes are used as reaction medium in pure form, as a mixture of various diphenylalkanes or as a mixture with other compounds which are suitable as reaction medium.

3. A process as claimed in claim 1 or 2, wherein the diphenylalkanes have alkyl chains having chain lengths of from 3 to 20 carbon atoms.

4. A process as claimed in claim 3, wherein the diphenylalkanes have alkyl chains having chain lengths of from 10 to 14 carbon atoms.

5. A process as claimed in any of claims 1 to 4, wherein monovalent or divalent copper salts are used as copper-containing catalysts.

6. A process as claimed in claim 6, wherein copper(II) hydroxide, copper(I) chloride or copper(I) or copper(II) oxide is used.

7. A process as claimed in any of claims 1 to 6, wherein monohydric alcohols having from 1 to 6 carbon atoms are used as alcohol.

8. A process as claimed in claim 7, wherein methanol or ethanol is used.

9. A process as claimed in any of claims 1 to 8, wherein the reaction is carried out at from 180 to 300° C.

10. The use of diphenylalkanes as inert reaction medium in the reaction of silicon metal with an alcohol over a copper-containing catalyst.
